(19) United States
(12) Patent Application Publication
(10) Pub. No.: US 2024/0312096 A1
(43) Pub. Date: Sep. 19, 2024

(54) PLAYBACK APPARATUS AND PLAYBACK METHOD

(71) Applicant: JVCKENWOOD Corporation, Yokohama-shi (JP)

(72) Inventor: Tomoyuki SHISHIDO, Yokohama-shi (JP)

(21) Appl. No.: 18/594,918

(22) Filed: Mar. 4, 2024

(30) Foreign Application Priority Data
Mar. 13, 2023 (JP) 2023-038568
Jan. 31, 2024 (JP) 2024-012695

(51) Int. Cl. G06T 13/40; G06T 19/20; G06V 10/764; G06V 20/52; G06V 40/16

(52) U.S. Cl. CPC G06T 13/40; G06T 19/20; G06V 10/764; G06V 20/53; G06V 40/174; G06T 2219/2004

(57) ABSTRACT

A playback apparatus according to an embodiment includes a recording control unit configured to record, when an avatar moves to a predetermined area to which an ID is assigned in a virtual space, state information indicating a state of the predetermined area and an action log of the avatar in the predetermined area in association with the ID in a recording unit; and a playback unit configured to play back, when an action of the avatar is to be played back in the predetermined area, the action of the avatar based on the action log when a state indicated by the state information recorded in association with the ID in the recording unit matches with a state of the predetermined area at the time of the playback.

### CROSS REFERENCE TO RELATED APPLICATION

This application is based upon and claims the benefit of priority from Japanese patent application No. 2023-038568, filed on Mar. 13, 2023 and Japanese patent application No. 2024-012695, filed on Jan. 31, 2024, the disclosure of which is incorporated herein in its entirety by reference.

### BACKGROUND

The present disclosure relates to a playback apparatus and a playback method.

In recent years, a service using a virtual space, in particular, the so-called metaverse space, to which an indefinite number of users can log in and interact with each other has evolved and is attracting attention. Unlike events in the past, users can log in to an event held in such a metaverse space from all over the world. However, regarding an event held in such a metaverse space, there may be a time period during which only a small number of users have logged in to the event due to, for example, the fact that users can log in to such events at any time they want. A user who participates in the event in such a time period may feel that the event is desolated, and hence the level of satisfaction of the user with his/her experience of the event may be lowered.

Therefore, recently, technologies for preventing the level of satisfaction of users with their experiences of events from being lowered have been proposed. For example, Japanese Unexamined Patent Application Publication No. 2022-184724 discloses a technology for preventing the level of satisfaction of a user with his/her experience of a passive-type event, such as an event in which the user views contents, from being lowered when the user is experiencing the event.

Specifically, according to the technology disclosed in Japanese Unexamined Patent Application Publication No. 2022-184724, a log of actions (hereinafter also referred to as an action log) of a first avatar operated by a first user is created while he/she is viewing contents, and when a second user views the contents after the first user has viewed the contents, the contents are played back and the actions of the first avatar are also played back based on the action log thereof. In this way, it is possible to produce a state in which the second user feels as if he/she is experiencing the event together with the first user.

### SUMMARY

However, in the case where the technology disclosed in Japanese Unexamined Patent Application Publication No. 2022-184724 is applied to an event that is held in a vast virtual space such as a metaverse space, and an avatar in the past is played back, in some cases, the actions of an avatar of a user who experienced an event that was held in a certain area during a limited period and has already finished is played back. In such a case, there is a problem that the image of an avatar who is behaving artificially in a currently empty area in the metaverse space may be played back, and hence the level of satisfaction of the currently-participating user with his/her experience of the event may be lowered instead of being improved.

A playback apparatus according to an embodiment includes:
a recording control unit configured to record, when an avatar moves to a predetermined area to which an ID is assigned in a virtual space, state information indicating a state of the predetermined area and an action log of the avatar in the predetermined area in association with the ID in a recording unit; and
a playback unit configured to play back, when an action of the avatar is to be played back in the predetermined area, the action of the avatar based on the action log when a state indicated by the state information recorded in association with the ID in the recording unit matches with a state of the predetermined area at the time of the playback.

A playback method according to an embodiment of the present disclosure is a playback method performed by a playback apparatus, including:
recording, when an avatar moves to a predetermined area to which an ID is assigned in a virtual space, state information indicating a state of the predetermined area and an action log of the avatar in the predetermined area in association with the ID in a recording unit; and
playing back, when an action of the avatar is to be played back in the predetermined area, the action of the avatar based on the action log when a state indicated by the state information recorded in association with the ID in the recording unit matches with a state of the predetermined area at the time of the playback.

### BRIEF DESCRIPTION OF THE DRAWINGS

The above and other aspects, advantages and features will be more apparent from the following description of certain embodiments taken in conjunction with the accompanying drawings, in which:

FIG. 1 shows an example of an image of a metaverse space when the number of users who have logged in to the metaverse space is large;

FIG. 2 shows an example of an image of a metaverse space when the number of users who have logged in to the metaverse space is extremely small;

FIG. 3 is a block diagram showing an example of a configuration of a playback apparatus according to a first embodiment;

FIG. 4 shows an example of event holding situations managed by an event management unit according to the first embodiment;

FIG. 5 shows an example in which an action log of an avatar is recoded together with an event holding situation of each area in a metaverse space in a recording unit according to the first embodiment;

FIG. 6 is a flow diagram for explaining an example of a general flow of operations that are performed when action of an avatar is played back by a playback apparatus according to the first embodiment;

FIG. 7 is a block diagram showing an example of a configuration of a playback apparatus according to a second embodiment;

FIG. 8 is a flow diagram for explaining an example of a general flow of operations that are performed when an action of an avatar is played back by a playback apparatus according to the second embodiment; and

FIG. 9 is a block diagram showing an example of a hardware configuration of a computer for implementing all or some of the functions of the playback apparatus according to the first or second embodiment.

### DETAILED DESCRIPTION

Embodiments according to the present disclosure will be described hereinafter with reference to the drawings. Note that the following descriptions and drawings are partially omitted and simplified as appropriate for clarifying the explanation. Further, in the drawings explained below, the same elements are assigned the same reference numerals (or symbols), and redundant explanations thereof are omitted as appropriate.

### First Embodiment

Firstly, prior to describing a playback apparatus 10 according to a first embodiment, how the impression of a metaverse space differs according to the number of users who have logged in to the metaverse space will be described.

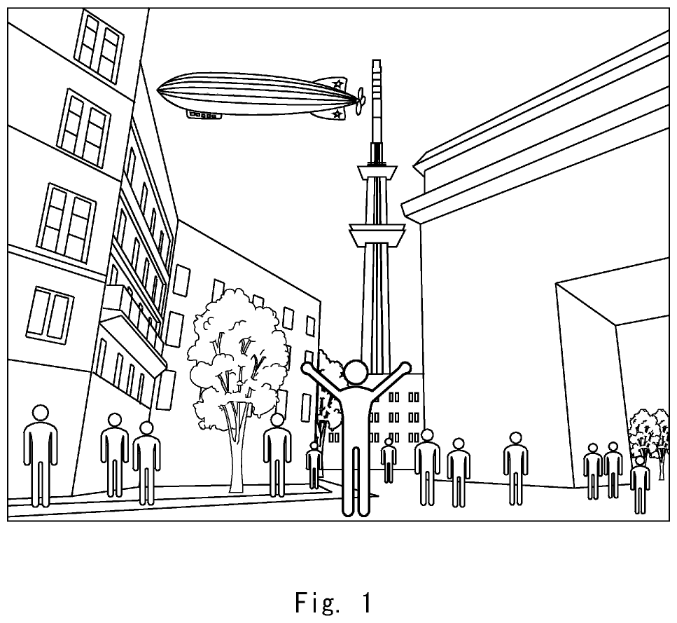

FIG. 1 shows an example of an image of a metaverse space when the number of users who have logged in to the metaverse space is large. In the metaverse space shown in FIG. 1, there are a lot of avatars in addition to the avatar of the user. Therefore, it is possible to give the user an impression that the metaverse space is a lively and bustling space.

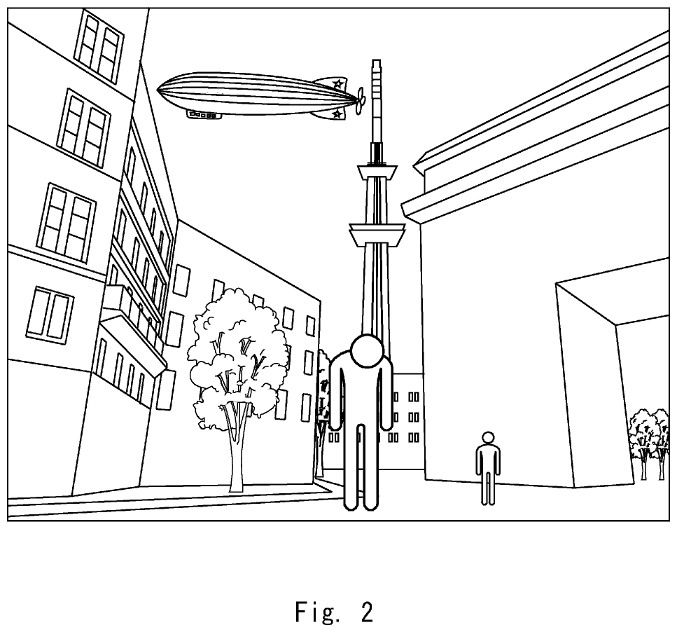

In contrast, FIG. 2 shows an example of an image of a metaverse space when the number of users who have logged in to the metaverse space is extremely small. In the metaverse space shown in FIG. 2, only one avatar other than the avatar of the user can be found. Therefore, the user is given an impression that the metaverse space is a dull and boring space. As a result, even if the user experiences an event held in the metaverse space, the level of satisfaction of the user with his/her experience of the event is significantly lowered.

The playback apparatus 10 according to the first embodiment is configured as described below in order to prevent a metaverse space in a situation like the one shown in FIG. 2 from being created.

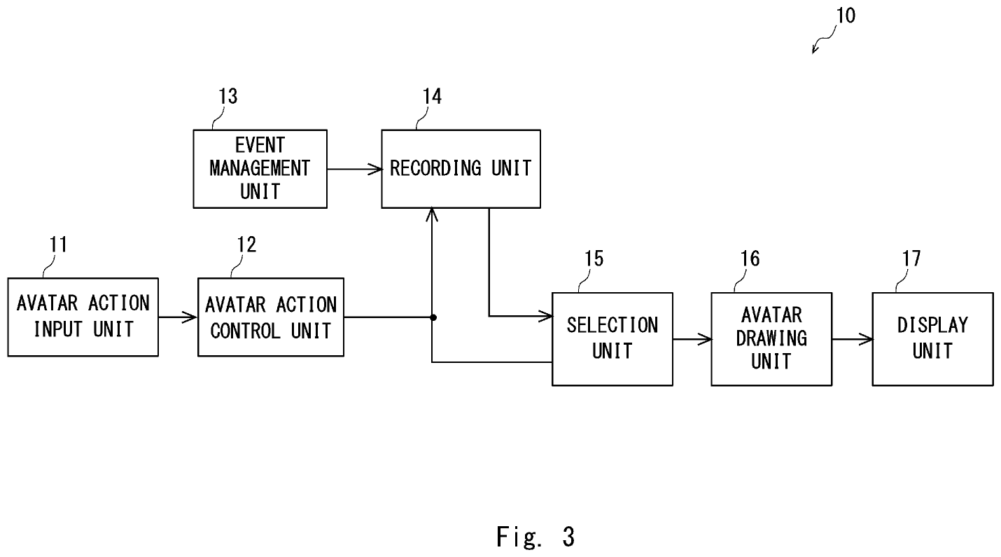

FIG. 3 is a block diagram showing an example of a configuration of the playback apparatus 10 according to the first embodiment.

As shown in FIG. 3, the playback apparatus 10 according to the first embodiment includes an avatar action input unit 11, an avatar action control unit 12, an event management unit 13, a recording unit 14, a selection unit 15, an avatar drawing unit 16, and a display unit 17. However, the recording unit 14 and the display unit 17 are not essential components of the playback apparatus 10, and may be provided outside the playback apparatus 10.

An instruction about an action of an avatar operated by a user who has logged in to the metaverse space is input to the avatar action input unit 11.

Based on the instruction input to the avatar action input unit 11, the avatar action control unit 12 generates action control data of the avatar which is data for controlling the action performed by the avatar in the metaverse space. The action control data of the avatar indicates movements of joints, a facial expression, a moving path, contents of a conversation, and the like of the avatar.

The event management unit 13 divides the metaverse space into arbitrary areas and manages an event holding situation of each of the areas in the metaverse space.

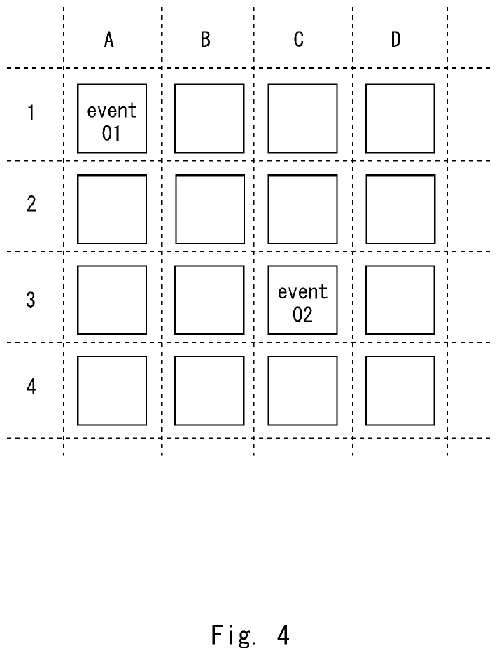

FIG. 4 shows an example of event holding situations managed by the event management unit 13. In FIG. 4, the metaverse space is divided into equally-divided areas.

As shown in FIG. 4, the event management unit 13 assigns an area ID (identification) to each of the areas obtained by dividing the metaverse space, and manages the event holding situations of areas to each of which an area ID is assigned in association with the assigned area ID. If a given event is held in a given area, the event management unit 13 associates the event ID of the given event with the area ID of the given area and manages them in association with each other. In the example shown in FIG. 4, an event having an event ID “event 01” is held in an area having an area ID “A1”, and an event having an event ID “event 02” is held in an area having an area ID “C3”. Therefore, the event management unit 13 manages the area ID “A1” in association with the event ID “event 01”, and manages the area ID “C3” in association with the event ID “event 02” Note that since no event is held in any of the other areas, the event management unit 13 associates no event ID to the area ID of any of the other areas.

The avatar action control unit 12 records, for each area in the metaverse space, an action log (e.g., movements of joints, a facial expression, a moving path, contents of a conversation, and the like of the avatar) corresponding to the action control data of the avatar together with the event holding situation of that area at the time when the user of that avatar logged in the metaverse space in the recording unit 14.

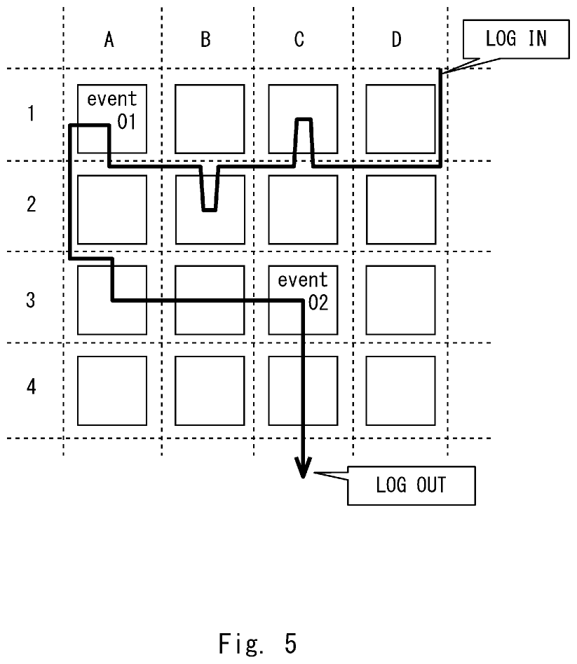

FIG. 5 shows an example in which an action log of an avatar, which is a moving path of the avatar, is recoded together with the event holding situation of each area in the metaverse space in the recording unit 14.

As shown in FIG. 5, the action log of the avatar is recorded together with the event holding situation of each area as shown in FIG. 4 in the recording unit 14. In the example shown in FIG. 5, the movement path of the avatar is recorded as the action log of the avatar. In this example, it is assumed that: the user logged in the metaverse space; his/her avatar moved along the path indicated by the arrow in the metaverse space; and the user logged out at the end of the arrow. The avatar successively moved through the area having the area ID “A1” where the event having the event ID “event 01” is held and the area having the area ID “C3” where the event having the event ID “event 02” is held. Further, regarding the event holding situation of each area, the event ID “event 01” is recorded in association with the area ID “A1”, and the event ID “event 02” is recorded in association with the area ID “C3”. For the area IDs of the other areas, no associated event ID is recorded.

When a user logs in to the metaverse space, the selection unit 15 selects the action control data of the avatar of that user generated by the avatar action control unit 12 and passes the selected action control data to the avatar drawing unit 16. The avatar drawing unit 16 draws the action of the avatar on the display unit 17 based on the action control data passed from the selection unit 15.

Further, when a user logs in to the metaverse space, the selection unit 15 compares the number of avatars currently present in the metaverse space (i.e., the number of users who has logged in to the metaverse space and has not logged out yet) with a predetermined threshold while performing the above-described operation or before performing the above-described operation. The selection unit may compare the number of avatars present in a predetermined area including the place where the user has logged in with a predetermined threshold. Note that areas that are located within a distance equivalent to a predetermined number of areas from the predetermined area are collectively defined as an adjacent area. The selection unit 15 may compare the sum total of the numbers of avatars who are present in the predetermined area or the adjacent area with a predetermined threshold.

As a result of the comparison, when the number of avatars present in the metaverse space is equal to or larger than the threshold, the action of an avatar is not played back. That is, the selection unit 15 selects no action log from the recording unit 14 in which the actions of avatars of users who logged in to the metaverse space in the past are recorded.

On the other hand, when the number of avatars present in the metaverse space is smaller than the threshold, the action(s) of an avatar(s) is played back. That is, the selection unit 15 selects an action log(s) from the recording unit 14 in which the actions of avatars of users who logged in to the metaverse space in the past are recorded.

The selection unit 15 compares the event holding situation of each area at the time of the playback with the event holding situation of that area recorded together with the action log of an avatar in the recording unit 14. In this way, the selection unit 15 can determine, for each area ID, whether the event ID associated with that area ID (hereinafter referred to simply as “the event ID for each area ID”) at the time of the playback of the action log differs from that at the time of the recording thereof. The selection unit 15 may select an action log from among those of users except for the user himself/herself, i.e., from among those of users other than the user himself/herself. The selection unit 15 may select a plurality of action logs, or may select a plurality of action logs until the number of selected action logs reaches a threshold or larger. The selection unit 15 may limit the number of action logs to be selected to a predetermined number. When the selection unit 15 selects a predetermined number of action logs from a plurality of action logs, it may compare the dates and times of the action logs with the date and time at the time of the playback, and thereby select action logs in ascending order of the difference therebetween.

As a result, when there is, among those recorded in the recording unit 14, an action log that was recorded in such a situation that its event ID exactly matches with the event ID for each area ID at the time of the playback, the selection unit 15 selects this action log. That is, the selection unit 15 selects an action log that was recorded in the same event holding situation as the event holding situation of each area at the time of the playback. Then, the selection unit 15 passes the selected action control data to the avatar drawing unit 16. The avatar drawing unit 16 draws (plays back) the action of the avatar on the display unit 17 based on the action control data passed from the selection unit 15.

On the other hand, when there is, among those recorded in the recording unit 14, no action log that was recorded in such a situation that its event ID exactly matches with the event ID for each area ID at the time of the playback, the selection unit 15 may select no action log and the avatar drawing unit 16 may not play back the action of any avatar.

Alternatively, even when there is an area ID for which the event ID at the time of the playback does not match with that at the time of the recording, the selection unit 15 can determine whether or not the avatar has entered the area having the area ID for which the event ID does not match. Therefore, when the avatar has not entered the area having the area ID for which the event ID does not match, the selection unit 15 may select the action log of that avatar and play back the action of that avatar.

Alternatively, even when the avatar has entered the area having the area ID for which the event ID at the time of the playback does not match with that at the time of the recording, if the stay time of the avatar is shorter than a certain length, it is considered that the avatar has not interfered with (e.g., has not had an interest in) the event. Note that the stay time is a difference between the time when the avatar entered the area to which the area ID is assigned and the time when the avatar left the area. Therefore, even when the avatar has entered the area having the area ID for which the event ID at the time of the playback does not match with that at the time of the recording, if the stay time of the avatar is shorter than the certain length, the selection unit 15 may select the action log of that avatar and play back the action of that avatar.

Note that the avatar action input unit 11 may be implemented by, for example, a controller for moving an avatar, a sensor attached to an HMD (Head Mounted Display), or the like. Further, the recording unit 14 may be implemented by, for example, a memory formed by a combination of a volatile memory and a nonvolatile memory. Further, the avatar action control unit 12, the event management unit 13, the selection unit 15, and the avatar drawing unit 16 may be implemented by, for example, a processor such as a microprocessor, an MPU (Micro Processing Unit), or a CPU (Central Processing Unit). Further, the avatar action control unit 12, the event management unit 13, the selection unit 15, and the avatar drawing unit 16 may be implemented by, for example, having a processor load and execute a program stored in a memory by which the recording unit 14 is implemented. Further, the display unit 17 may be implemented by, for example, a display device.

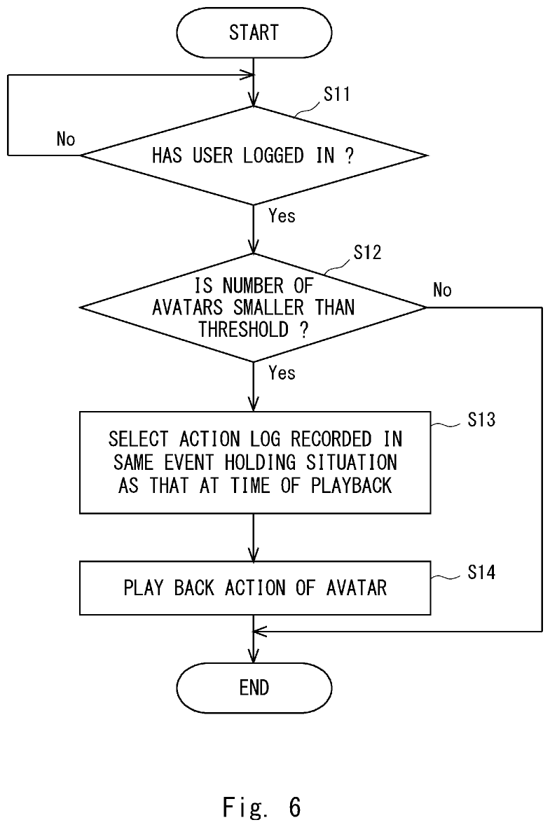

FIG. 6 is a flow diagram for explaining an example of a general flow of operations that are performed when an action of an avatar is played back by the playback apparatus 10 according to the first embodiment. Note that in FIG. 6, it is assumed that action logs of avatars of users who logged in to the metaverse space in the past are already recorded together with the event holding situation of each area in the metaverse space at the time of the log-in in the recording unit 14.

As shown in FIG. 6, the selection unit 15 determines whether or not a user has logged in to the metaverse space (Step S11). When no user has logged in (No in Step S11), the process returns to the step S11.

When a user has logged in to the metaverse space in the step S11 (Yes in Step S11), the selection unit 15 compares the number of avatars currently present in the metaverse space with a predetermined threshold (Step S12).

When the number of avatars is smaller than the threshold in the step S12 (Yes in Step S12), the selection unit 15 selects, from among those recorded in the recording unit 14, an action log of an avatar that was recorded in an event holding situation that is the same as the event holding situation in each area at the time of the playback (Step S13).

After that, the avatar drawing unit 16 draws (plays back) the action of the avatar on the display unit 17 based on the action control data corresponding to the action log of the avatar selected by the selection unit 15 (Step S14).

On the other hand, when the number of avatars is equal to or larger than the threshold in the step S12 (No in Step S12), the selection unit 15 determines not to select the action log of any of the avatars in the past and finishes the series of processes.

Note that although only the action log that was recorded in an event holding situation that is the same as the event holding situation in each area at the time of the playback is selected in the step S13 in the example shown in FIG. 6, the present disclosure is not limited to this example. As described above, when the avatar has not entered the area having the area ID for which the event ID at the time of the playback does not match with that at the time of the recording, the selection unit 15 may select the action log of that avatar. Further, even when the avatar has entered the area having the area ID for which the event ID at the time of the playback does not match with that at the time of the recording, if the stay time of the avatar is shorter than the certain length, the selection unit 15 may select the action log of that avatar and play back the action of that avatar.

As described above, according to the first embodiment, the avatar action control unit 12 records an action log of an avatar of a user who logged in to the metaverse space in the past together with the event holding situation of each area in the metaverse space at the time of the log-in in the recording unit 14. After that, when a user logs in to the metaverse space and when the number of avatars currently present in the metaverse space is smaller than the threshold, the selection unit 15 selects, from among those recorded in the recording unit 14, an action log of an avatar that was recorded in an event holding situation that is the same as the event holding situation for each area at the time of the playback. The avatar drawing unit 16 plays back the action of the avatar based on the action log of the avatar.

In this way, it is possible to produce a lively metaverse space even in a time period during which the number of users who have logged in to the metaverse space is small. Therefore, a user who sees an avatar who is acting according to its action log feels as if there is a user who is not the user himself/herself and is operating the avatar in real time. Therefore, the user can obtain a high level of satisfaction when he/she experiences an event held in the metaverse space. As a result, it is possible to prevent the level of satisfaction of the user with his/her experience of the event in the metaverse space from being lowered.

Note that in the first embodiment, when an action of an avatar in the past is played back, the selection unit 15 selects the action log of all the actions of the avatar in the metaverse space, and the avatar drawing unit 16 plays back all the actions of the avatar in the metaverse space. However, the present disclosure is not limited to this example. For example, the selection unit 15 may select only an action log of an action of the avatar performed in the area where the event is held, and the avatar drawing unit 16 may play back only the action of the avatar performed in the area where the event is held. Further, in this case, the avatar action control unit 12 does not need to record all the actions of the avatar performed in the metaverse space as the action log, and may record only an action(s) of the avatar performed in the area where the event is held as the action log.

Further, although the selection unit 15 determines whether or not an event at the time of the recording is the same as that at the time of the playback by using an event ID thereof in the first embodiment, the present disclosure is not limited to this example. For example, it is considered that, for an area where the same event is held a plurality of times, the state of the area is the same for each event. Therefore, the selection unit 15 may determine whether or not the event is the same according to whether or not the area where the event is held is in the same state. Further, it is considered that the same objects are arranged in the area where the same event is held. Therefore, the selection unit 15 may determine whether or not the area is in the same state according to whether or not objects arranged in the area are the same. For example, when the area is located outside, objects arranged in the area are buildings, roads, vehicles, and the like. Further, when the area is located inside, objects arranged in the area are walls, floors, ceilings, furniture, and the like. When the selection unit 15 determines whether or not the area at the time of the recording is in the same state as the state at the time of the playback, the selection unit 15 may determine whether some or all of the objects match.

Further, it is assumed that events have been continuously held from the past to the present time in the first embodiment. However, an event that had been held in the past may be held as a revival. In such a case, the event management unit 13 preferably manages the event ID of the event to be held as a revival by using the same event ID as that of the event held in the past. In this way, it is possible to, in the event to be held as a revival, play back an action of an avatar of a user who experienced the event held in the past.

Further, it is assumed that the metaverse space is divided into areas and an event is held in some of these areas in the first embodiment. However, some events (such as fireworks) are held over a wide area (i.e., over a large number of areas) in the metaverse space. When the divided areas are small in such an event, it is difficult to divide the metaverse space into areas having the same shape or the same size. Therefore, when such an event is held, the event management unit 13 may manage a plurality of area IDs by associating the same event ID with them.

### Second Embodiment

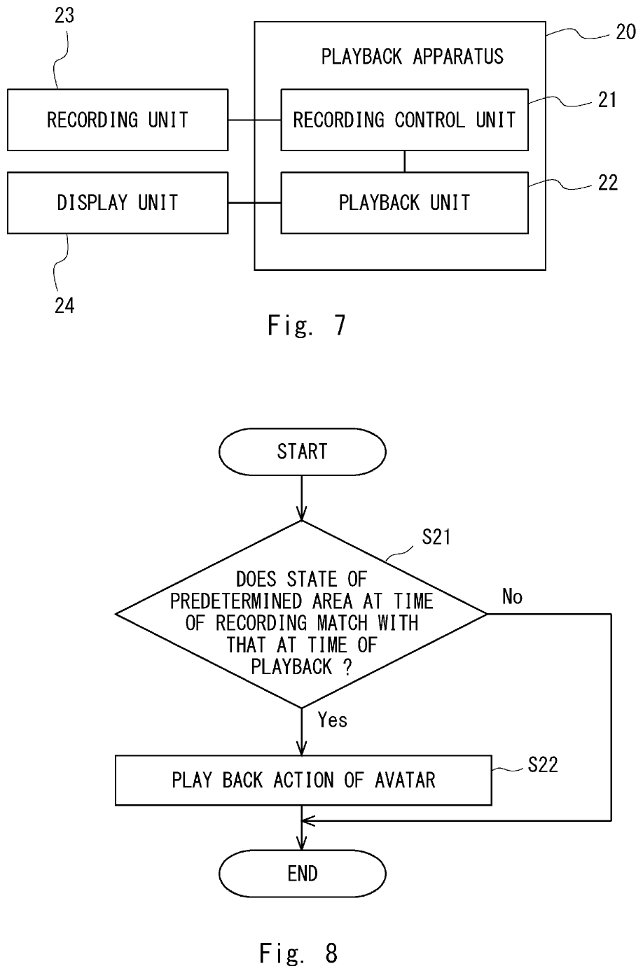

FIG. 7 is a block diagram showing an example of a configuration of a playback apparatus 20 according to a second embodiment. The second embodiment corresponds to an embodiment in which the above-described first embodiment is generalized.

As shown in FIG. 7, the playback apparatus 20 according to the second embodiment includes a recording control unit 21 and a playback unit 22.

Note that the recording control unit 21 corresponds to the avatar action control unit 12 and the event management unit 13 according to the above-described first embodiment. Further, the playback unit 22 corresponds to the selection unit and the avatar drawing unit 16 according to the above-described first embodiment.

When an avatar moves to a predetermined area to which an ID is assigned in a virtual space, the recording control unit 21 records state information indicating the state of the predetermined area and the action log of the avatar in the predetermined area in association with the ID in a recording unit 23 located outside the playback apparatus 20. The recording unit 23 corresponds to the recording unit 14 according to the above-described first embodiment, but is not limited to those disposed outside the playback apparatus 20. That is, the recording unit 23 may be disposed inside the playback apparatus 20. Note that the predetermined area is an area that is obtained by dividing the virtual space in a predetermined range, and may not be an equally-divided area.

The recording control unit 21 may include, as the state information of the predetermined area, information about an event in the predetermined area, the time when the avatar entered the predetermined area, the time when the avatar left the predetermined area, the duration or the time period in which the avatar was present in the predetermined area, the number of other avatars at that time, the number of avatars per unit area (i.e., the congestion level), and state information of the adjacent area.

The playback unit 22 plays back the action of the avatar on a display unit 24 located outside the playback apparatus 20 based on the state information and the action log recorded in association with the ID in the recording unit 23. The display unit 24 corresponds to the display unit 17 according to the above-described first embodiment, but is not limited to those disposed outside the playback apparatus 20. That is, the display unit 24 may be disposed inside the playback apparatus 20.

Note that when the playback unit 22 plays back an action of an avatar in a predetermined area, it plays back the action of the avatar based on the action log of the avatar when the state indicated by the state information recorded in association with the ID in the recording unit 23 matches with the state of the predetermined area at the time of the playback.

The playback unit 22 may determine whether or not the state indicated by the state information matches with the state at the time of the playback by using a predetermined threshold. When a difference between the time indicated by the state information and the time of the playback is within a predetermined threshold, the playback unit 22 may determine that the time indicated by the state information matches with the time at the time of the playback. For example, when the threshold is one hour and the state information indicates that the time is 12:00, the playback unit 22 may determine that the state at the time of the recording matches with that at the time of the playback when the time at the time of the playback is between 11:00 and 13:00.

The playback unit 22 compares the number of avatars present in the predetermined area with a first threshold, and may play back the action of the avatar when the number is smaller than the first threshold. The playback unit 22 may not play back the action of the avatar when the number of avatars present in the predetermined area is equal to or larger than the first threshold.

The playback unit 22 may increase the first threshold when the predetermined area is large, or decrease the first threshold when the area is small.

The playback unit 22 may compare the congestion level of the predetermined area with a second threshold, and play back the action of the avatar when the congestion level is lower than the second threshold. The playback unit 22 may not play back the action of the avatar when the congestion level of the predetermined area is equal to or higher than the second threshold.

FIG. 8 is a flow diagram for explaining an example of an outline flow of operations that are performed when an action of an avatar is played back by the playback apparatus 20 according to the second embodiment. Note that in FIG. 8, it is assumed that when an avatar has moved to a predetermined area to which an ID is assigned in a virtual space, state information indicating states of the predetermined area and action logs of avatars in the predetermined area were already recorded in association with IDs in the recording unit 23.

As shown in FIG. 8, when the playback unit 22 plays back an action of an avatar in the predetermined area, it compares the state indicated by the state information recorded in association with the ID in the recording unit 23 with the state of the predetermined area at the time of the playback (Step S21).

When the state of the predetermined area matches in the step S21 (Yes in Step S21), the playback unit 22 plays back the action of the avatar based on the action log of the avatar (Step S22).

On the other hand, when the state of the predetermined area does not match in the step S22 (No in Step S21), the playback unit 22 does not play back the action of the avatar and finishes the series of processes.

As described above, according to the second embodiment, when an avatar moves to a predetermined area to which an ID is assigned in a virtual space, the recording control unit 21 records state information indicating the state of the predetermined area and the action log of the avatar in the predetermined area in association with the ID in the recording unit 23. When the playback unit 22 plays back an action of an avatar in a predetermined area, it plays back the action of the avatar based on the action log of the avatar when the state indicated by the state information recorded in association with the ID in the recording unit 23 matches with the state of the predetermined area at the time of the playback.

In this way, it is possible to produce a lively virtual space even in a time period during which the number of users who have logged in to the metaverse space is small. Therefore, it is possible to, when a user experiences an event held in a virtual space, to prevent the level of satisfaction of the user with his/her experience of the event from being lowered.

Note that when an avatar moves to a predetermined area to which an ID is assigned, the recording control unit 21 may further record, in the recording unit 23, time information indicating the time period during which the avatar stayed in the predetermined area in association with the ID. Further, when the playback unit 22 plays back an action of an avatar in a predetermined area, it may play back the action of the avatar based on the action log of the avatar when the time period indicated by the time information recorded in association with the ID in the recording unit 23 is a shorter than a predetermined length.

Further, the state information may include information about a predetermined object(s) disposed in the predetermined area. Further, when a predetermined object(s) is disposed in the predetermined area at the time of the playback, the playback unit 22 may determine that the state of the predetermined area matches. Note that examples of objects may be the same as those described above in the first embodiment.

Further, when the playback unit 22 plays back an action of an avatar in a predetermined area, it may not play back the action of the avatar when the number of avatars present in the virtual space is equal to or larger than a predetermined threshold.

Further, when an avatar moves to a predetermined area to which an ID is assigned, the recording control unit 21 may classify the attribute of the user who is operating the avatar into a class and record class information indicating the class in which the attribute has been classified in association with the ID in the recording unit 23. Note that examples of the attribute of the user may include an age, a gender, an address/place of residence, a family structure, an occupation. Further, the class may be, for example, an age group when the attribute of the user is his/her age. That is, the class is a group in which attributes of a user are classified. Note that, for example, the recording control unit 21 may determine the attribute of the user who is operating the avatar based on the action of the avatar that has been performed until the avatar moves to (i.e., reaches) the predetermined area. Alternatively, when user information including the attribute of the user is obtained in advance, such as when the attribute of the user is recorded in the recording unit 23, the recording control unit 21 may determine the attribute of the user from the user information.

Note that the avatar of the user who operates the avatar is referred to as a first avatar. The term “first avatar” is used when it is necessary to distinguish between the first avatar and other avatars. The playback unit 22 draws the first avatar.

In this case, the playback unit 22 may play back, when it plays back the action of the avatar in the predetermined area, the action of the avatar based on the action log of the avatar when the attribute of the user operating the first avatar matches with the class indicated by the class information recorded in association with the ID in the recording unit 23. Note that the attribute of the user and the method for determining the attribute of the user may be the same as those described above.

Further, the playback unit 22 may play back, when it plays back the action of the avatar based on the action log in the predetermined area, the action of the avatar based on the action log of the avatar when the state of the predetermined matches, and the attribute of the user operating the first avatar matches with the class indicated by the class information recorded in association with the ID in the recording unit 23.

Further, the playback unit 22 may classify the attribute of the user into a predetermined class based on the attribute of the user who is operating the first avatar.

In this case, the playback unit 22 may play back, when it plays back the action of the avatar in the predetermined area, the action of the avatar based on the action log of the avatar when the class in which the attribute of the user operating the first avatar is classified matches with the class indicated by the class information recorded in association with the ID in the recording unit 23.

Further, attribute information indicating the attribute of the user may be recorded in the recording unit 23 in advance, and the playback unit 22 may classify the attribute of the user into a class during the playback of the action of the avatar.

Further, the playback apparatus 20 may include an operation unit 25 (not shown) connected to the recording control unit 21, and the operation unit 25 may receive various operations from the user through the display surface by the touch panel, or may receive various operations from the user by various buttons, a keyboard, or a mouse. The operation unit 25 may display images or the like, instead of on the display surface of the touch panel, on the display unit 24 through the playback unit 22. The user may enter the attribute of the user through the operation unit 25, and the playback apparatus 20 may record the entered attribute of the user in the recording unit 23.

Alternatively, when an avatar moves to a predetermined area, the recording control unit 21 may further record attribute information indicating the attribute of the user operating the avatar in association with the ID in the recording unit 23. In this case, the playback unit 22 may play back, when it plays back the action of the avatar during the drawing of an action of a first avatar in the predetermined area, the action of the avatar based on the action log of the avatar when the state of the predetermined area matches, and a difference between the attribute of the user operating the first avatar and the attribute indicated by the attribute information recorded in association with the ID in the recording unit 23 is in a predetermined range. Note that the attribute of the user and the method for determining the attribute of the user may be the same as those described above.

Further, in the case where the attribute information of the user and the attribute information recorded in association with the ID in the recording unit 23 are quantitatively expressed information such as numerical values, the playback unit 22 may play back the action log of the avatar when the difference between the attribute information of the user and the attribute information recorded in association with the ID is smaller than a predetermined threshold.

Further, when the attribute information of the user and the attribute information recorded in association with the ID in the recording unit 23 are qualitatively expressed information such as words, the playback unit 22 may convert words representing each of these attribute information pieces into a vector representation. Note that for the conversion of words into vector representations, for example, a technology for generating vector representations such as word 2vec can be used. The playback unit 22 may play back the action log of the avatar when the difference between these two vectors obtained by converting the words into vector representations is smaller than a predetermined threshold.

Further, the playback unit 22 converts the attribute of the user and the predetermined class into vector representations, and if the difference between the vectors of the user and the predetermined class is smaller than the predetermined threshold value, it may be determined that the user and the predetermined class are the same.

Further, when an avatar moves to a predetermined area, the recording control unit 21 may further classify the emotion of the user who is operating the avatar into a class based on the contents of a conversation of the avatar or biometric information of the user operating the avatar and record class information indicating the class in which the emotion has been classified in association with the ID in the recording unit 23.

Further, the playback apparatus 20 may further include an operation unit 25 (not shown) connected to the recording control unit 21, and the operation unit 25 may receive a conversation from the user by a microphone. The recording control unit 21 may analyze the emotion in regard to the contents of the conversation and classify the emotion of the user into a predetermined class (e.g., into one of positive/neutral/negative).

Further, the recording control unit 21 may convert voices of the contents of the conversation into text by a voice recognition technology, analyze the text through natural language processing, and classify the emotion from the text by using a machine learning model that has learned a relationship between text and emotions.

Further, the recording control unit 21 may extract features of voices (such as the frequency of voices, the volume of voices, and the speed of the conversation) from the contents of the conversation and classify the emotion from the features of voices by using a machine learning model that has learned a relationship between features of voices and emotions.

Note that the biometric information of the user may be, for example, a heart rate acquired by using a heart rate meter or an application of a smartphone and/or a body temperature acquired by using a thermographic camera or a thermometer.

Further, regarding the class of the emotion, the emotion may be classified into, for example, one of positive/neutral/negative. Note that, for example, the recording control unit 21 may determine whether or not the user is excited from the heart rate, the body temperature, and/or the like of the user, and determine the emotion of the user based on the result of this determination

In this case, when the playback unit 22 plays back the action of the avatar based on the action log in the predetermined area, it may change the amount (e.g., the extent) of the action of the avatar to be played back based on the class indicated by the class information recorded in association with the ID in the recording unit 23, and based on the action log. Note that, for example, the playback unit 22 may change the amounts of movements of joints recorded as the action log of the avatar. Further, the playback unit 22 may, for example, increase the amount of the action of an avatar operated by a user who is in a positive state (e.g., 1.1 times) and decrease the amount of the action of an avatar operated by a user who is in a negative state (e.g., 0.9 times).

Alternatively, the playback unit 22 may not select the action log of an avatar operated by a user who was in a negative state. That is, when the playback unit 22 plays back the action log of an avatar in the predetermined area, it may select the action log of an avatar operated by a user who was in a positive state or a neutral state and play back the action of the avatar based on the selected action log when the state of the predetermined area matches.

Note that it is considered that the emotion of a user who operates an avatar is not always constant, and the emotion may rise and fall. Therefore, the recording control unit 21 may record class information in association with the ID on an hourly basis instead of recording only one type of class information related to the emotion of the user. In this way, the playback unit 22 can play back, in an hourly basis, the avatar according to the amount of the action corresponding to the class related to the emotion at that time.

Further, when the playback unit 22 plays back the action of an avatar based on the action log during the drawing of the action of a first avatar in the predetermined area, the recording control unit 21 may determine whether or not the user who is operating the first avatar is concentrated. Then, when the user operating the first avatar is not concentrated, the recording control unit 21 may thin out the data of the action log recorded in the recording unit 23 and transfer the thinned-out data of the action log to the playback unit 22. In this process, for example, the recording control unit 21 may detect the line of sight of the user operating the first avatar by using a camera or the like, and thereby determine whether or not the user is concentrated or not based on whether or not the line of sight is unstable. Further, the recording control unit 21 may also determine that the line of sight of the user operating the first avatar is unstable when the amount of movement or the number of movements of the line of sight per unit time of the user operating the first avatar is equal to or larger than a threshold. As described above, it is possible to reduce the amount of the action log to be transferred by thinning out the amount of the data of the action log recorded in the recording unit 23 and transferring the thinned-out data thereof.

Further, when the amount of the action log recorded in the recording unit 23 is larger than a predetermined threshold, the recording control unit 21 may thin out the data of the action log.

In this case, the recording control unit 21 may thin out the data of the action log recorded in the recording unit 23 at predetermined time intervals. For example, it is assumed that when the recording control unit 21 does not thin out the data of the action log recorded in the recording unit 23, the data of the action log is transferred to the playback unit 22 at intervals of 30 times per second. Under this assumption, when the recording control unit 21 thins out the data of the action log recorded in the recording unit 23, it may transfer the data of the action log to the playback unit 22 at intervals of 10 times per second.

### <Computer for Implementing Playback Apparatus According to Embodiment>

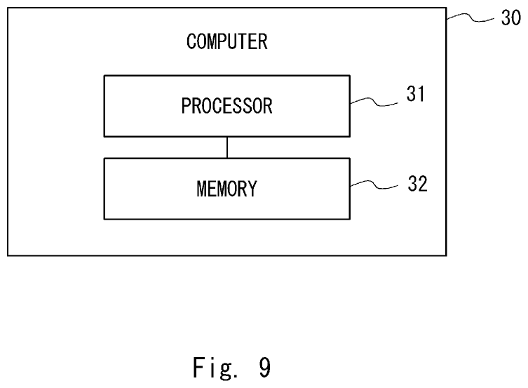

FIG. 9 is a block diagram showing an example of a hardware configuration of a computer 30 for implementing all or some of the functions of the playback apparatus 10 or 20 according to the first or second embodiment.

As shown in FIG. 9, the computer 30 includes a processor 31 and a memory 32.

The processor 31 may be, for example, a microprocessor, an MPU, or a CPU. The processor 31 may include a plurality of processors.

The memory 32 is formed by a combination of a volatile memory and a nonvolatile memory. The memory 32 may include a storage disposed remotely from the processor 31. In this case, the processor 31 may access the memory 32 through an I (Input)/O (Output) interface (not shown).

A program(s) is stored in the memory 32. This program includes a group of instructions (or software code) for making, when being loaded into the computer 30, the computer 30 perform some of the functions of the playback apparatus 10 or according to the above-described first or second example embodiment. The components in the above-described playback apparatuses 10 and 20 may be implemented by having the processor 31 load a program(s) stored in the memory 32 and execute the loaded program(s). Further, the storing function in the above-described playback apparatus 10 or 20 may be implemented by the memory 32.

Further, the above-described program may be stored in a non-transitory computer readable medium or a tangible storage medium. Examples of the computer readable medium or the tangible storage medium include, but are not limited to, a random-access memory (RAM), a read-only memory (ROM), a flash memory, a solid-state drive (SSD) or other memory technologies, a CD-ROM, a digital versatile disc (DVD), a Blu-ray (Registered Trademark) disk or other optical disk storages, a magnetic cassette, a magnetic tape, and a magnetic disk storage or other magnetic storage devices. The program may be transmitted through a transitory computer readable medium or a communication medium. Examples of the transitory computer readable medium or the communication medium include, but are not limited to, an electrically propagating signal, an optically propagating signal, an acoustically propagating signal, or other forms of propagating signals.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A playback apparatus comprising:
a recording control unit configured to record, when an avatar moves to a predetermined area to which an ID is assigned in a virtual space, state information indicating a state of the predetermined area and an action log of the avatar in the predetermined area in association with the ID in a recording unit; and
a playback unit configured to play back, when an action of the avatar is to be played back in the predetermined area, the action of the avatar based on the action log when a state indicated by the state information recorded in association with the ID in the recording unit matches with a state of the predetermined area at the time of the playback.

2. The playback apparatus according to claim 1, wherein
the state information includes information about a predetermined object disposed in the predetermined area, and
when the predetermined object is disposed in the predetermined area at the time of the playback, the playback unit determines that the state of the predetermined area matches.

3. The playback apparatus according to claim 1, wherein when the playback unit plays back the action of the avatar in the predetermined area, the playback unit plays back the action of the avatar when the number of avatars present in the virtual space or a congestion level of the predetermined area is smaller than a predetermined threshold.

4. The playback apparatus according to claim 1, wherein
when an avatar moves to the predetermined area, the recording control unit further records, in the recording unit, time information indicating a time period during which the avatar stayed in the predetermined area in association with the ID, and
when the playback unit plays back an action of an avatar in the predetermined area, the playback unit plays back the action of the avatar based on the action log when the time period indicated by the time information recorded in association with the ID in the recording unit is a shorter than a predetermined length.

5. The playback apparatus according to claim 1, wherein
when an avatar moves to the predetermined area, the recording control unit classifies an attribute of a user operating the avatar into a class and further records class information indicating the class in which the attribute has been classified in association with the ID in the recording unit, and
the playback unit plays back the action of the avatar in the predetermined area, the playback unit plays back based on the action log when the class in which the attribute of the user has been classified matches the class indicated by the class information recorded in association with the ID in the recording unit.

6. The playback apparatus according to claim 1, wherein
when an avatar moves to a predetermined area, the recording control unit classifies an emotion of a user operating the avatar into a class based on a content of a conversation of the avatar or biometric information of the user operating the avatar and records class information indicating the class in which the emotion has been classified in association with the ID in the recording unit, and
when the playback unit plays back the action of the avatar in the predetermined area, the playback unit changes an amount of the action of the avatar to be played back based on the class indicated by the class information recorded in association with the ID in the recording unit, and based on the action log.

7. The playback apparatus according to claim 1, wherein when the playback unit plays back the action of the avatar in the predetermined area, the recording control unit determines whether or not a user operating the avatar is concentrated; and when the user is not concentrated, the recording control unit thins out data of the action log and transfer the thinned-out data of the action log to the playback unit.

8. A playback method performed by a playback apparatus, comprising:
recording, when an avatar moves to a predetermined area to which an ID is assigned in a virtual space, state information indicating a state of the predetermined area and an action log of the avatar in the predetermined area in association with the ID in a recording unit; and
playing back, when an action of the avatar is to be played back in the predetermined area, the action of the avatar based on the action log when a state indicated by the state information recorded in association with the ID in the recording unit matches with a state of the predetermined area at the time of the playback.
